(19) United States
(12) Patent Application Publication
(10) Pub. No.: US 2024/0068290 A1
(43) Pub. Date: Feb. 29, 2024

(54) EDDY CURRENT BRAKING DEVICES FOR MOVING DOORS AND OTHER STRUCTURES

(71) Applicant: Nicholas Martin Klietsch, Charlotte, NC (US)

(72) Inventor: Nicholas Martin Klietsch, Charlotte, NC (US)

(21) Appl. No.: 18/238,621

(22) Filed: Aug. 28, 2023

Related U.S. Application Data
(60) Provisional application No. 63/401,418, filed on Aug. 26, 2022.

(51) Int. Cl. E05F 5/00

(52) U.S. Cl. CPC E05F 5/003; E05Y 2201/21; E05Y 2201/246; E05Y 2201/258; E05Y 2201/266; E05Y 2201/408; E05Y 2201/462; E05Y 2201/668; E05Y 2900/132

(57) ABSTRACT

A movement damping device travels along a fixed track on roller wheels. Trolleys mounted on the roller wheels support the door along the track for movement of the door. Eddy-current interaction occurs between travelling magnets mounted on the device and fixed side plates of the track. The trolley moves horizontally as the roller wheels travel along horizontal support rails of the track. The track would be fixed to a supporting host structure and opposing side plates of the track support the respective rails. The trolley travels between the side plates when the door moves. The relative motion between the magnets and the side plates causes eddy-currents in the conducting side plates and consequent motion resistance

### CROSS-REFERENCE TO RELATED APPLICATION

This application claims the benefit of priority of U.S. provisional patent application No. 63/401,418, titled “Eddy Current Braking Devices for Moving Doors and Other Structures,” filed on Aug. 26, 2022, which is incorporated herein in its entirety by this reference.

### BACKGROUND

Sliding door systems are common in office buildings, hotels and conference rooms. Just as cabinet drawers have bumpers or soft-close drawer slides to prevent slamming, so do todays' sliding door systems. Many office furniture suppliers offer a variety of wall systems and office designs; they are generally constructed using extruded aluminum framing and allow integration of an aluminum track for installations featuring sliding doors.

Most companies offer their products (office and door systems) with a variety of options or features. For example, basic, low-cost office systems may have sliding glass office doors that operate with a set of free-rolling trolleys and rubber end stops to prevent damage from slamming. This type of system may suffice for light-use and/or low door weight (perhaps resin panels retained in an aluminum frame or a cabinet-sized glass door), but will not suffice for heavier wood or glass doors located in frequent use/high traffic environments. Rubber bumpers (or end-stops) alone are insufficient for doors with any significant weight to their construction, so a soft-close device is frequently incorporated into the sliding door assembly.

The above-described devices generally perform well; however, in high traffic applications or in applications with extremely heavy sliding doors (>120 kg), the lifespan of the soft-close devices are dramatically reduced. When these devices fail, the door's impact with the end stop becomes violent and installers must be sent out to the site/facility to replace the soft close devices. In virtually all scenarios, the door must be removed from the track and lower guide, a task which generally requires at least two people. Depending on how the door track is integrated with the surrounding wall/office system, the process of replacing the soft-close devices will vary greatly in both time and involvement. Replacement time for one of these failed units typically ranges anywhere from 30 minutes for an experienced team of two installers, to over two hours. The labor cost associated with replacing failed soft-close units can surpass the cost of the device itself. In large commercial applications, these costs are often the responsibility of the company supplying the office/door systems.

A few companies have incorporated mechanical friction devices into track or trolley assemblies as a means to limit or reduce a sliding door's total momentum to either reduce the total load on the soft-close devices, or to enable the use of rubber bumpers with heavier door applications. The drawback of these devices are as follows:
(1) The additional sliding resistance occurs immediately and continuously, increasing the door's inertia and negatively impacting the feel of operation;
(2) The amount of friction introduced is rarely enough to prevent an “accidental slam” towards the closed position since the friction required to prevent this would significantly increase the effort required by the user to operate the door; and
(3) Any type of mechanical friction will generally result in either heat degradation, mechanical wear/degradation over time, audible noise, or all the above. A friction mechanism that evades all of these failure modes would require a great deal of engineering and testing, while still being subject to the previously listed drawbacks.

From the end user's perspective (and therefore, that of the furniture/office system manufacturer) the ideal sliding door system would be one that exhibits a light to moderate initial weight (inertia), rolls/slides quietly with little to no effort, and contacts the end-stop gently, either by use of a soft close or by gentle contact with a damper or rubber end-stop. This “ideal” system would also be robust in high traffic environments (like hospitals, airports, conference rooms) and would be resistant to “accidental slam” or abuse situations.

A smooth rolling door that operates with little or no resistance is often the desired goal. However, in real world operation, a heavy door with minimal rolling resistance is prone to accidental slams/abusive or unintentional impacts which put tremendous stress on soft-close and soft-stop devices.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

A motion damping system for a movable door includes, in at least one embodiment: a trolley having rotatable wheels, the trolley configured for mounting a movable door; a stationary track on which the rotatable wheels are supported, the stationary track including an electrically conducting material; and a braking follower attached to the trolley, the braking follower including at least one magnet array in proximity to the electrically conducting material of the stationary track. Upon movement of the trolley relative to the stationary track, the braking follower is moved by the trolley relative to the stationary track such that the at least one magnet array causes eddy currents in the electrically conducting material and thereby resists the movement. The electrically conducting material may be or may include aluminum.

The braking follower can have a proximal end attached to the trolley, and a distal end having roller wheels.

The follower can includes a chassis extending longitudinally from the proximal end to the distal end; and the at least one magnet array can be mounted on a first lateral side of the chassis.

A second magnet array may be mounted on a second lateral side of the chassis.

The stationary track can include vertical side plates supporting respective horizontal rails on which the rotatable wheels are supported such that movement of the trolley relative to the stationary track causes eddy currents in the vertical side plates.

The movement damping device, in at least one example, includes: at least one frame member; an axle mounted on the frame member; at least one roller wheel rotatably mounted on the axle; a hub rotatably mounted on the axle with the roller wheel, the hub comprising an electrically conductive material; and at least one magnet section non-rotatably attached to the frame. Upon rotation of the roller wheel, the hub is rotated relative to the at least one magnet section such that eddy currents in the electrically conducting material cause resistance against the rotation.

The at least one magnet section comprises a first cylindrical shell section magnet concentrically nested at least partially around the hub.

A second cylindrical shell section magnet can be non-rotatably attached to the frame and concentrically nested at least partially around the hub.

The device, in some examples, includes base from which the at least one frame member extends, the base configured for mounting the movement damping device to a movable host structure for damping movement thereof.

A motion damping system is provided for coupling to a movable structure to which motion damping is applied by the system. The motion damping system includes a movement damping device and a flexible line. The device includes a frame, and a braking pulley including a hub rotatably attached to the frame, and at least a first flange extending radially outward from the hub. The first flange includes an electrically conducting material. At least one magnet is non-rotatably attached to the frame adjacent the first flange. The flexible line engages the hub of the braking pulley, the flexible line having at least one end for attachment to a movable structure. Upon linear movement of the flexible line relative to the movement damping device, the flexible line causes rotation of the braking pulley such that eddy currents in the electrically conducting material of the first flange causes resistance against the rotation. The electrically conducting material may be or may include aluminum.

The movement damping device may include at least a first ring array of magnets, including the at least one magnet, non-rotatably attached to the frame adjacent the at least one flange, each of the magnets of the first ring array, upon rotation of the braking pulley, causes eddy currents in the electrically conducting material and resistance against the rotation.

The braking pulley may further include a second flange extending radially outward from the hub, the second flange including an electrically conducting material. The movement damping device may further include a second ring array of magnets non-rotatably attached to the frame adjacent the second flange. Each of the magnets of the second ring array, upon rotation of the braking pulley, causes eddy currents in the electrically conducting material of the second flange and resistance against the rotation.

The flexible line may include a toothed belt, and the hub may have a toothed engagement surface for positively engaging the toothed belt without slipping.

In the above or other embodiments, an eddy current braking device for moving doors is provided by which relative motion between a magnetic surface and a non-magnetic conductive surface causes eddy-currents in the conducting surface and consequent motion resistance. The device includes at least one magnetic surface/magnetic array, whereby the relative motion between the magnetic field and the conductor occurs with any one or multiple surfaces of the track serving as the electrically conductive surface.

Magnetic array(s) can be mounted or integrated onto a follower chassis which is affixed to one or more of the rolling/suspension trolleys.

An eddy current braking device can be used in conjunction with or integrated into the construction of a soft-close/damper device.

The motion of a door can be transferred via drivetrain, gearbox or timing belt and pulley to a flywheel arrangement whereby the relative motion between the magnetic array occurs axially along one or more planes.

An eddy current braking device can include a belt affixed to one or two trolleys and that runs through pulleys at either one or both ends of a track; wherein power is transferred from a small pulley, through a shaft to a conductive disk(s), along which a magnetic array/magnetic surface acts.

An eddy current braking device is provided in which relative motion between a magnetic surface/array occurs radially along rollers or trolley wheels.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is a side view of a movement damping device having a braking follower, according to at least one embodiment, installed on a top edge of a sliding door for use in or as a soft-close system.

FIG. 2 is another side view of the movement damping device in the installation of FIG. 1, shown with a track by which the door can be mounted, via the movement damping device, to an architectural structure such as framing over a doorway.

FIG. 3 is an enlarged side view of the movement damping device of FIG. 1.

FIG. 4 is an enlarged perspective view of the movement damping device of FIG. 1.

FIG. 5 is a cross section view, taken at the line 5-5 in FIG. 2, along a longitudinal axis of the damping device and track.

FIG. 6 is a cross section view, taken at the line 6-6 in FIG. 2, along a longitudinal axis of the damping device and track.

FIG. 7 is a side view of the movement damping device shown with an exemplary magnet array, according to at least one embodiment, mounted on a top edge of a sliding door.

FIG. 8 is a side view of the movement damping device shown with an exemplary magnet array, according to another embodiment, mounted on a top edge of a sliding door.

FIG. 9 shows an unmounted magnet array as in FIG. 8.

FIG. 10 shows an unmounted magnet array according to yet another embodiment.

FIG. 11 diagrammatically represents a Halbach arrangement among adjacent magnets in an array as known.

FIG. 12 is a perspective view of a movement damping device having magnetic braking wheels, according to at least one embodiment.

FIG. 13 is a side view of the movement damping device of FIG. 12 within a track.

FIG. 14 is a longitudinal end view of the movement damping device of FIG. 12 within the track of FIG. 13.

FIG. 15 is cross sectioned perspective view of the movement damping device taken along the line 15-15 in FIG. 14.

FIG. 16 is a cross-sectioned longitudinal view of the movement damping device and track taken along the line 16-16 in FIG. 13.

FIG. 17 is a perspective view of a line-coupled damping device having a braking pulley, according to at least one embodiment, in an installation with a moving door.

FIG. 18 is an enlarged perspective view of the line-coupled damping device of FIG. 17.

FIG. 19 is an enlarged perspective view of the line-coupled damping device as in FIG. 18, with the housing shown in dashed line for illustration of other components and their relative arrangement.

FIG. 20 is top view of the braking pulley of the line-coupled damping device of FIGS. 17-19.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments. The below described examples and embodiments are accordingly to be taken as cumulative, and can be implemented together or separately.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

In various embodiments, the descriptions disclose eddy current brake devices for use with sliding doors and other implementations where soft close systems are needed. Various embodiments described and implied herein utilize the interaction that occurs when an electrically conductive, non-magnetic surface travels through a magnetic field (Lenz's law). Speed-limiting/braking devices described and implied herein utilize the resistive eddy current interaction.

Benefits of eddy current braking devices in implementations according to these descriptions and those implementation further coming to mind in view of these descriptions, include:
Non-contact interaction and virtually maintenance-free durability;
Imparts a braking force that acts continuously throughout the stroke of the door, limiting the total kinetic energy that may be achieved;
operates continuously throughout the stroke but a velocity-dependent relation between door speed and induced magnetic resistance means braking/resistive force may be close to or equal to zero at low speed (20 mm/s), but quite significant at higher speeds (100 mm/s);
Can extend the life of soft-close/damper devices; and
Introduces the ability to adjust the haptics/motion characteristics of a sliding door based on user preferences.

An advantage of eddy braking is that it is contactless, thus there is no or minimal mechanical wear. Eddy current based braking is not as highly effective at low speed braking as for higher speeds, and because the conductor has to be moving, eddy brakes do not generally hold objects in stationary positions.

These descriptions, of which the drawings are a part, detail in various embodiments an eddy current braking device, for example for sliding doors, whereby the relative motion between a magnetic surface, array, or element of an inventive device and a non-magnetic conductive surface is directly driven by the physical operation of opening and closing the door. The device, in some embodiments, is in operation continuously across an entire range of motion and by nature of the interaction, imparts a velocity-dependent force which acts opposite to the direction of motion. The amount of physical resistance the device imparts may be tuned as desired (by adjusting magnet size/quantity/strength, separation distance between magnet array and conductor, etc.) for a particular implementation or environment.

Inventive devices described herein generally dissipate kinetic energy to limit the speed at which a door (or rolling panel, sliding hardware, etc.) may be operated in order to limit/reduce the total kinetic energy upon reaching a stop point such an track end-stop.

These devices may also dissipate and/or limit kinetic energy/velocity of the door (or rolling panel, sliding hardware, etc.) in order to protect and maintain the integrity of any soft-close or damper device. Thus, inventive devices described herein may be used in lieu of, or in conjunction with, various soft-close or damper devices in various embodiments.

In additional functions and potential uses of these devices, haptics experiences/perceptions may be provided to customers and uses. For certain types of objects, people tend to associate weight with quality. These devices can be tuned for a particular application/door weight, and can likewise be tuned to impart a high resistive force on a lightweight door to give a user a similar feel as a much heavier solid wood door. The velocity-dependent resistance is similar in feel to a viscous friction damper, which can be found in countless automotive application.

In a various embodiments, an eddy current braking device for sliding doors is provided in which relative motion between a magnetic surface and a non-magnetic conductive surface (a conductor) is resisted by induced electromotive force.

In some embodiments, a device includes at least one magnetic surface/magnetic array, whereby the relative motion between the magnetic field and the conductor occurs with any one or multiple surfaces of the track serving as the electrically conductive surface.

The magnetic array(s) may be mounted or integrated onto a follower chassis which is affixed to one or more of the rolling/suspension trolleys.

In some embodiments, the motion of the door is transferred via drivetrain, gearbox or timing belt and pulley to a flywheel arrangement whereby the relative motion between the magnetic array occurs axially along one or more planes. In some embodiments, a belt affixed to one or both trolleys runs through pulleys at either one or both ends of the track. Power may be transferred from a small pulley, through a shaft to a conductive disk(s), along which a magnetic array/magnetic surface acts.

In other embodiments, the relative motion between the magnetic surface/array occurs radially along the rollers or trolley wheels themselves.

It is understood that permanent magnets, as generally described above and illustrated for brevity, and/or electromagnets may be used to generate the magnetic flux for eddy-current braking.

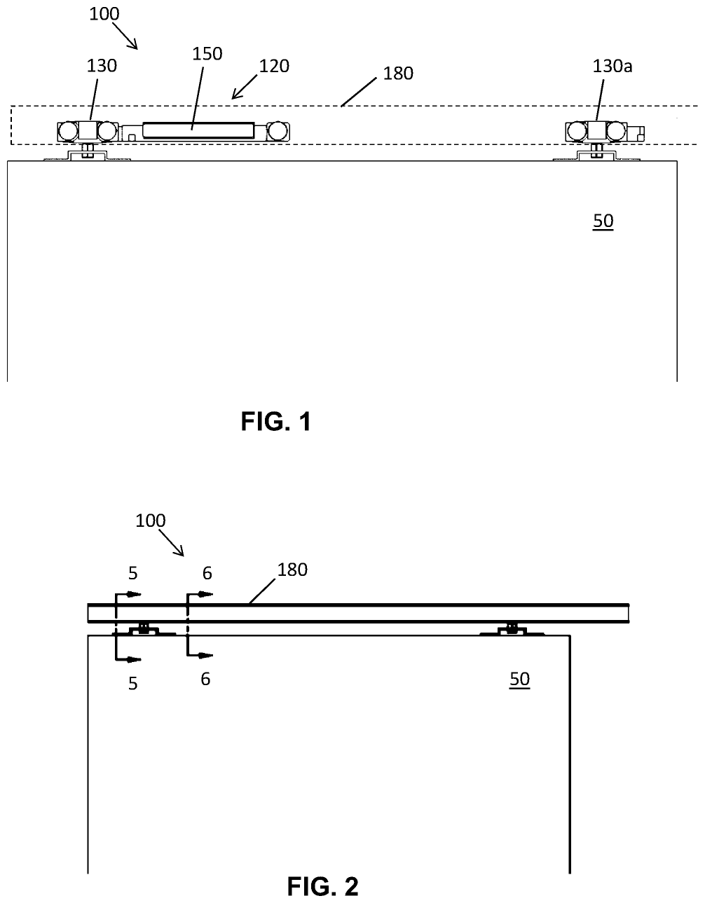

Specific details in the below descriptions and arrangements shown in the referenced drawings are provided as non-limiting examples. An embodiment of a soft-close system 100 includes a movement damping device 120 (FIG. 1) and a fixed track 180. The track 180 is to be installed on an architectural supporting host structure such as a stationary frame over a doorway, and the damping device 120 is to be installed along a top edge of a door 50 or other sliding structure as illustrated in FIGS. 1-2. The damping device 120 travels linearly within the fixed track 180, supporting the door or structure by way of the track, while providing eddy current braking.

In the illustrated example, the door 50 is essentially supported by the trolleys 130 and 130a, each having roller wheels that engage and roll within the track. A braking follower 150 with a magnet array is attached to and travels with at least one of the trolleys. The follower 150 carries at least one magnet array (160, 162) by which eddy currents are produced in the electrically conducting non-ferromagnetic track 180. The track 180 may be made of extruded or otherwise formed aluminum, as a non-limiting example. Thus, motion relative to the track by the trolley 130, and any structure carried by the trolley 130 such as the illustrated door 50, is resisted by induced electromotive force. Aluminum is an advantageous material for construction of or inclusion in the track for affordability and for supporting eddy current braking without exhibiting ferromagnetic attraction. Other electrically conducting non-ferromagnetic materials that can be used include, but are not limited to, copper, brass, gold, silver, and titanium.

A mutually orthogonal system of axes illustrated in FIG. 4 serves as a convention by which various components of the system and their movements are described herein. An expectedly horizontal axis of movement of the trolley along the rack, for example, is referenced as the longitudinal axis 102. An expectedly horizontal laterally extending axis, perpendicular to the longitudinal axis, is referenced as a transverse axis 104. An expectedly vertical third axis, completing the mutually orthogonal set, is referenced as a vertical axis 106, for example along which a supported door would hang. References to relative directions in the following are made with respect to this convention without imparting limitations on the system and its components.

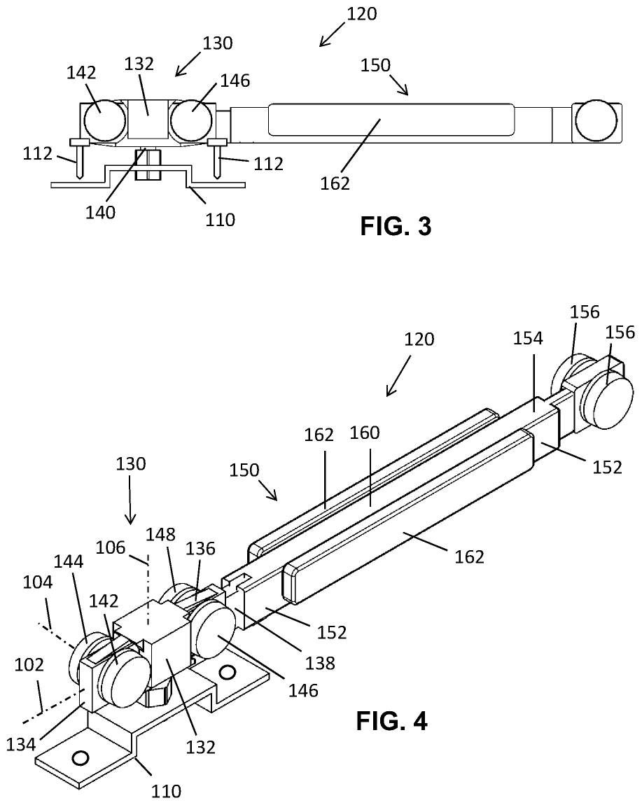

The trolley 130 has a base 132 from which two members extend in opposing forward and rearward longitudinal directions for mounting respective pairs of rollers. The two members are illustrated and referenced as a forward plate 134 and a rearward plate 136. A threaded post 140 serving as a hanger bolt extends downward from the base for attachment to a bracket 110 having holes, in the illustrated embodiment, for attachment of the bracket and trolley 120 therewith to a movable host structure, such as a door 50, using for example fasteners 112 (FIG. 3) such as screws. At the lower end of the post 140, a head and a threaded nut engaging the threaded post traps the bracket on the post.

A forward pair of roller wheels is mounted on the forward plate 134, and includes a first forward roller wheel 142 and a second forward roller wheel 144 rotatably mounted on opposing lateral sides of the forward plate 134. A rearward pair of roller wheels is mounted on the rearward plate 136, and includes a first rearward roller wheel 146 and a second rearward roller wheel 148 rotatably mounted on opposing lateral sides of the rearward plate. A tabbed extension 138 extends from the rearward plate 136 for attachment of a follower 150 that carries at least one magnet array.

A second trolley 130a is illustrated as also mounted on the door 50 in FIG. 1. The two trolleys 130 and 130a are spaced along the top of the door to share the weight of the door and maintain is orientation. The second trolley 130a can be constructed alike that described with reference to the trolley 300, requiring no second descriptions here.

The roller wheels of the trolleys 130 and 130a roll along the track for movement of the door. For eddy-current interaction, some degree of electrical conductance in a nearby fixed element is needed proximal to the magnet array 120 carried by the damping device 120. The track 130 can accordingly be constructed of aluminum as already described, as a non-limiting example, or other conducting metal, facilitating eddy-current interaction and optionally having little or no ferromagnetic property.

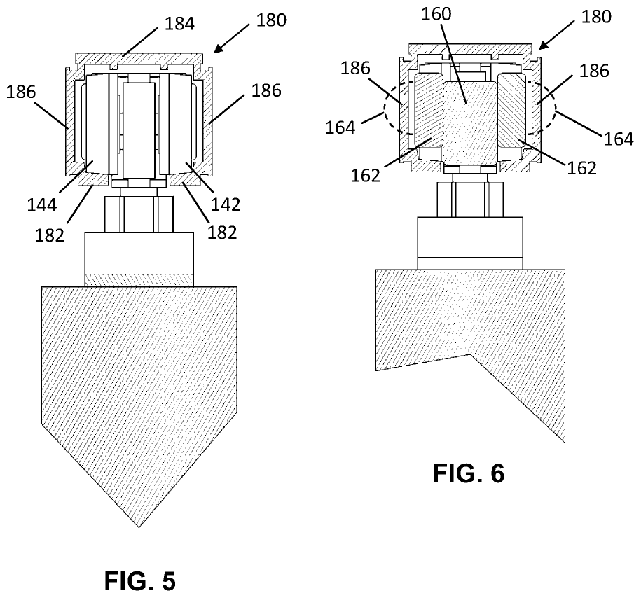

FIG. 5 shows the rollers wheels 142 and 144 that travel with the movement damping device 130 engaging the track 180. The track 180 of the illustrated example defines a downward opening C-channel in which the trolley 130 moves horizontally as the roller wheels travel along horizontal support rails 182 of the track. In the illustrated embodiment, an internally ribbed top plate 184 of the track would be fixed to a supporting host structure. Opposing vertical side plates 186 extend from the top plate to the rails, supporting the rails 132. The trolley travels between the side plates when the door moves. In other embodiments, the track structure can vary from the illustrated example. There are other possibilities for track geometry, and methods of attaching the track to the support structure can also vary (side mount, top mount, snap-in). The track could even take the form of a wall-mounted or ceiling-mounted J-shape where the trolley wheels are inline.

The follower 150 travels with the trolley. In the illustrated embodiment, the follower has a mounted proximal end 152 attached to the tabbed extension 138 of the trolley, and a floating distal end 154 having roller wheels 156 that roll on the rails 182 of the track 180 to support the follower 150 as parallel to the track and within the defined C-channel. The follower 150 has a generally linear chassis 160 (FIG. 4) connecting the distal end 154 to the proximal end 152. A respective magnet array 162 is attached to each lateral side of the chassis such that the magnet arrays 162 move along with the trolley 130 in close proximity to the respective conducting side plates 186 of the track 180.

In FIG. 6, the magnetic fields 164 along the outer sides of the respective magnet arrays 162 mounted on the chassis 150 are shown for illustration without necessarily quantifying or mapping actual field distributions in any physical implementation of a movement damping device according to these descriptions. Due to proximity of each travelling magnet array 162 with a respective stationary side plate 186, magnetic braking occurs by movement of the door 50 and follower 150 relative to the track 180. In other embodiments, magnet arrays can be fixed, for example to the track 180, and/or along the side plates, top plate, and/or rails, as non-limiting examples. Thus the illustrated device 120 damps rapid motion and resists excessive speeds in both opening and closing movements with reference to the implementations of the drawings in which the motion of a sliding door is damped.

The chassis 150, which is illustrated as a longitudinally extending beam with a rectangular profile, is rigid along its length to withstand compression, tension, and shear forces for durable use and life of the illustrated device and to facilitate braking by motion resistance in any direction along the track 180. The chassis 150 can be constructed of metal or plastic, and other materials, providing a mounting substrate for the magnetic arrays 162 and a means of connecting them to the trolley 130. If used in conjunction with a soft-close or mechanical damper device, the soft closer/damper housing could serve as the chassis. In some examples, a mechanical or viscous friction soft-close device could be integrated into this assembly.

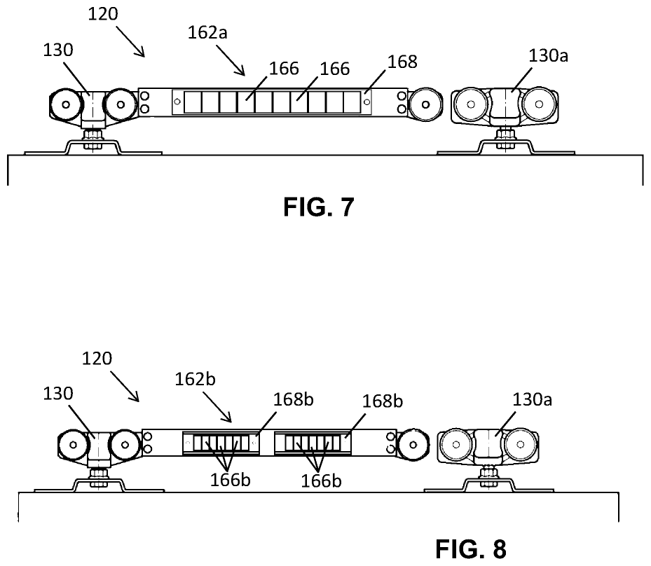

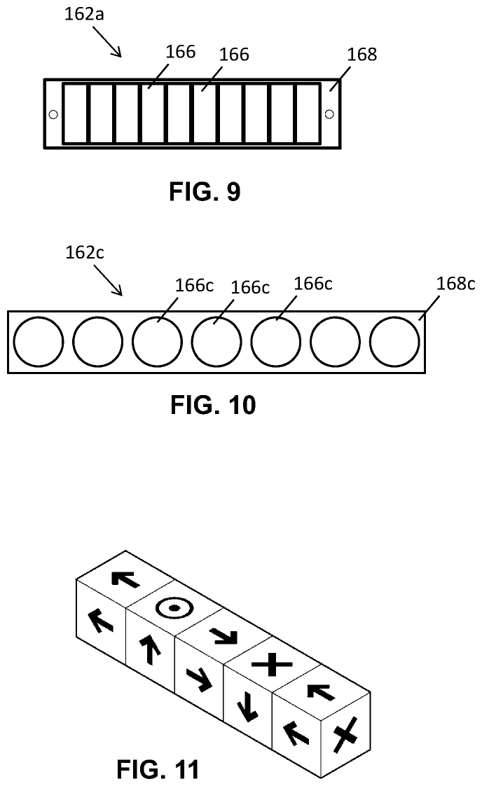

FIGS. 7-10 illustrate magnet array elements in non-limiting examples of implementation representing the magnet arrays 162. For example, an embodiment of the magnet array 162 referenced as a magnet array 162a in FIG. 7 has multiple magnets 166 mounted on a plate 168. An embodiment of the magnet array 162 referenced as a magnet array 162b in FIG. 8 has multiple magnets 166b mounted respectively along multiple plates 168b. Both rectangular and circular magnets are shown in various examples. For example, an embodiment of the magnet array 162 referenced as a magnet array 162c in FIG. 10 has multiple circular magnets 166b mounted along a plate 168c.

In various examples where multiple magnets are used in an given implementation, the magnetic polarities (direction of field flux) of the magnets can be arranged in various ways. For example, a Halbach array arrangement can be used to augment the magnetic field on one side of the array closest a side plate of a fixed track while minimizing the field on the other side facing the chassis. As known, a Halbach array arrangement, represented diagrammatically in FIG. 11, has a spatially rotated pattern of magnetization among adjacent magnets in an array. Any and all magnet arrays referenced herein may be implemented using a Halbach arrangement of their magnets.

The examples in the drawings overall are advantageous by way of convenient implementation with existing sliding door arrangements. For example, commercially available damped closure sliding door assemblies include trolleys that travel along tracks to support a moving door, with a soft closure device following a trolley. In such examples, an existing system can be conveniently improved by use of the magnet loaded follower(s) 150 as in FIGS. 3-4 without excessive redesign of the support of the door. The examples in the drawings could be adapted to perform the same functions (or serve the same purpose) on J-shaped or non-channel tracks.

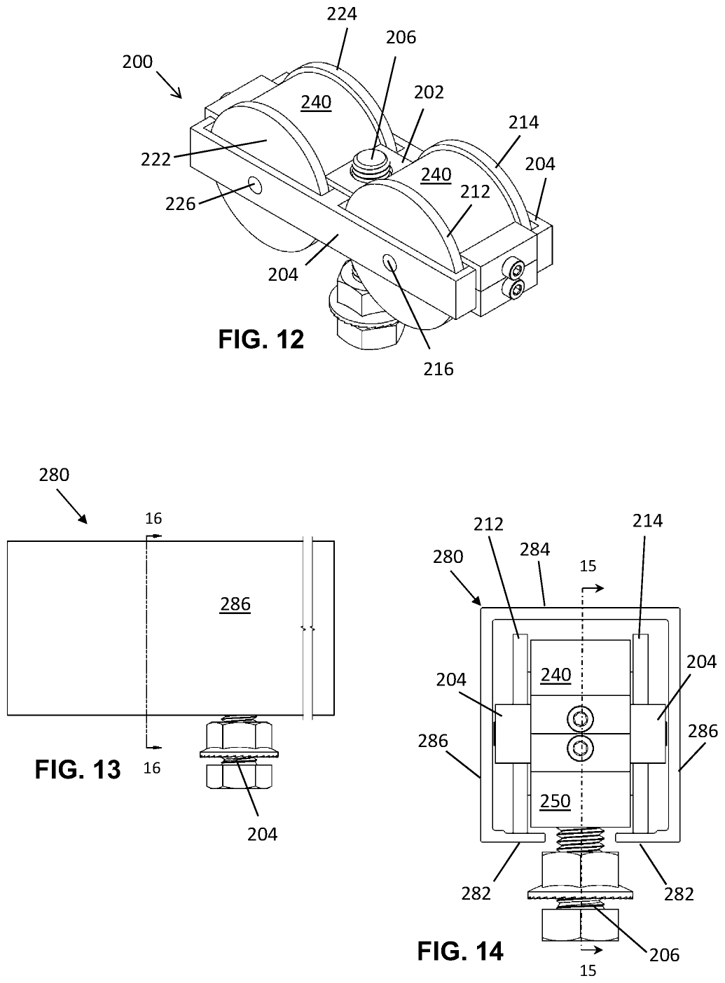

FIGS. 12-16 illustrate, in various views and perspectives, a movement damping device 200 according to another embodiment having an outer form factor similar to the trolley in the preceding descriptions and drawings. The damping device 200 is advantageously useful where similar trolleys, both those as expressly shown and those coming to mind in view of these drawings and descriptions, are used or can be used in sliding doors and other moving objects where motion damping is wanted. The movement damping device 200 is useful as self-braking self-contained trolley, with or without another braking device attached such as the magnet loaded follower 150.

In the embodiment of FIGS. 12-16, a non-rotating magnet array has sections placed around an electrically conductive rotatable hub, which rotates with and is carried by the roller wheels. Relative movement of the hub and magnet array sections occurs when the roller wheels are rotated relative to the housing, causing eddy currents in the hub. Thus motion of the device 200 along a rail or track by rotation of the roller wheels is resisted by induced electromotive force.

The trolley-form damping device 200 has a base 202 from which and around which frame members 204 extend in opposing forward and rearward longitudinal directions for mounting respective pairs of rollers. A threaded post 206 serving as a hanger bolt extends downward from the base for attachment to a bracket 110 (FIGS. 3-4) or other mounting element for mounting the device 200 on a movable host structure, such as a door, where motion damping is wanted.

A forward pair of roller wheels is mounted between the frame members, and includes a first forward roller wheel 212 and a second forward roller wheel 214 rotatably mounted on a forward axle 216 that spans the frame members 204. A rearward pair of roller wheels is mounted between the fame members 204, and includes a first rearward roller wheel 222 and a second rearward roller wheel 224 rotatably mounted on a rearward axle 226 that spans the frame members 204. For each pair of roller wheels, an electrically conductive rotatable hub (230, 232) in collar form is mounted on the respective axle by way of inner portions of the structure of the wheels.

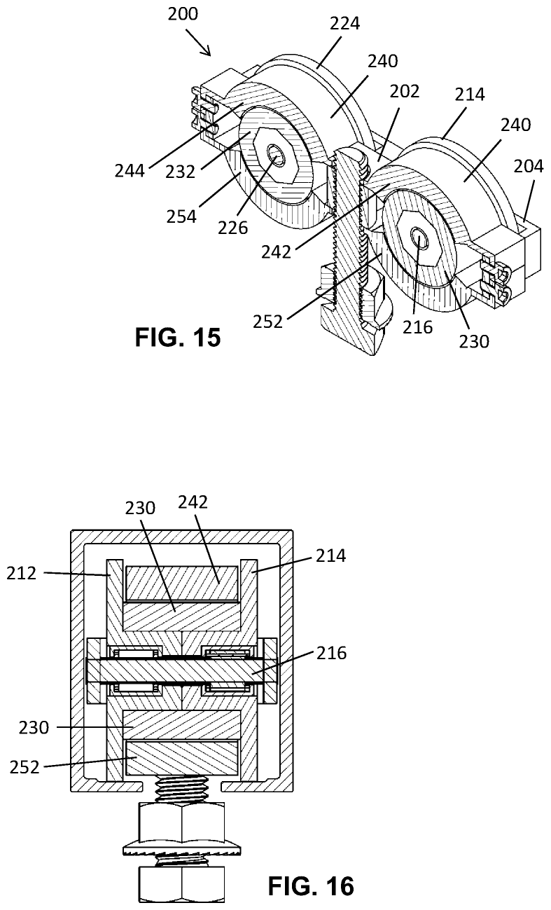

Non-rotating magnet-loaded cupped covers, referenced as an upper cover 240 and a lower cover 250 (FIG. 14), are mounted on the frame members 204. Each cover has a forward section and a rearward section. With the frame members 204, the upper cover 240 and a lower cover 250 define a housing at least partially enclosing the rotating hubs from above and below. A forward section of the upper cover 240 carries a forward upper non-rotating magnet section 242 (FIG. 15), formed as a cylindrical shell section, that is concentrically nested above and partially around the forward hub 230. A rearward section of the upper cover 240 carries a rearward upper non-rotating magnet section, formed as a cylindrical shell section, that is concentrically nested above and partially around the rearward hub 232.

Similarly, a forward section of the lower cover 250 carries a forward lower non-rotating magnet section 252 (FIG. 15), formed as a cylindrical shell section, that is concentrically nested below and partially around the forward hub 230. A rearward section of the lower cover carries a rearward lower non-rotating magnet section 254, formed as a cylindrical shell section, that is concentrically nested below and partially around the rearward hub 232.

By way of the covers 240 and 250, the above-referenced magnet sections are non-rotationally attached to the frame members and base, and are thus carried, without rotation, along with any movement of the trolley, for example as the trolley travels by rotation of the roller wheels.

FIG. 14 shows the trolley-form damping device 200 installed in and ready for travel along a track 280. The track of the illustrated example defines a downward opening C-channel in which the device 200 moves horizontally as the roller wheels travel along horizontal support rails 282 of the track. In the illustrated embodiment, a top plate 284 of the track would be fixed to a supporting host structure during installation. Opposing vertical side plates 286 extend from the top plate 284 to the rails, supporting the inwardly extending rails. Rotation of the hubs (230, 232) relative to the magnet array sections occurs when the roller wheels are rotated along the track 280 or other support elements, causing eddy currents in the hubs. Thus motion of the device 200 by rotation of the roller wheels is resisted by induced electromotive force. The hubs can be constructed of aluminum, as a non-limiting example, or other conducting metal, facilitating eddy-current interaction and optionally having little or no ferromagnetic property.

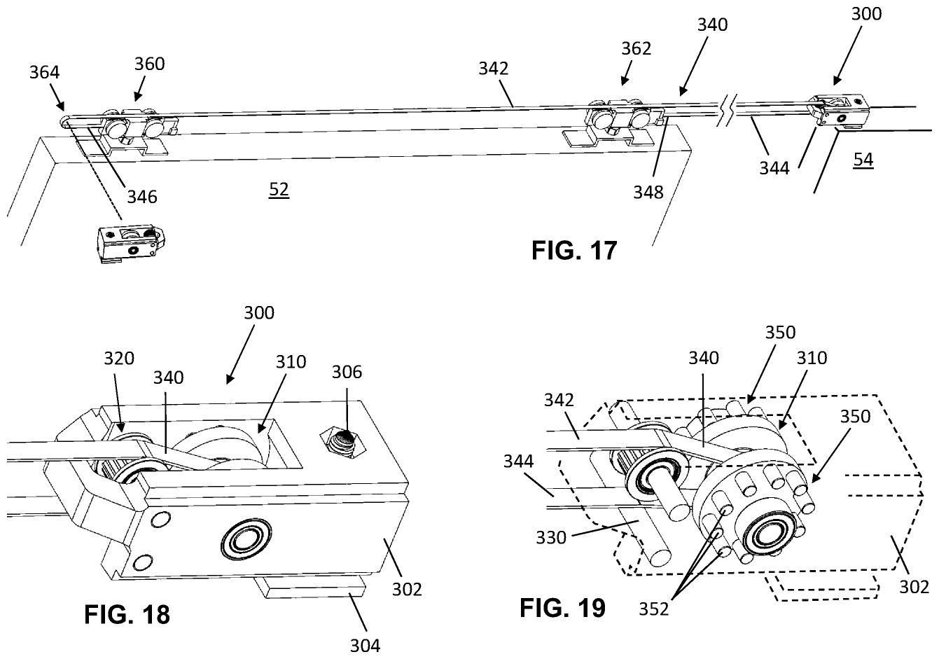

FIGS. 17-20 illustrate, in various views and perspectives, a movement damping device 300 for coupling to a moving structure 52, such as a door, by a tensile flexible line, referenced as a toothed belt 340 in the drawings. Other types of tensile flexible lines within the scope of these drawings include, but are not limited to, cords, cables, chain, rings, and bands. The damping device 300 in the illustrated embodiment includes a housing 302 for stationary mounting, and stationary non-rotating magnet arrays within the housing. A braking pulley 310 is rotatably mounted on an axle within the housing and is rotated by the belt 340 upon movement of a coupled moving structure 52 for which motion damping is wanted. The braking pulley 310 is constructed at least in part with electrically conductive material in which eddy currents are effected by the magnet arrays when the pulley is rotated. Thus, motion of the belt 340 relative to the housing 302, causing rotation of the braking pulley 310, is resisted by induced electromotive force.

The housing 302 is shown in dashed line in FIG. 19 for illustration of other components and their relative arrangement. The housing 302 has a foot 304 (FIG. 18) to be fixed to a supporting stationary host structure 54 during installation, for example by a mounting screw 306 (FIG. 18) or other fastener. The braking pulley 310 has a hub 312 engaged and rotated by the belt 340. In the illustrated embodiment, the hub 312 has a toothed engagement surface to positively engage the toothed belt without slipping. A respective circular flange 314 extends radially outward from the hub and thus having a greater diameter than that of the hub 312 is attached to each lateral end of the hub.

A freely rotating tensioner wheel 320, also illustrated as toothed, is mounted on an axle within housing forward of the braking pulley 310 and guides an upper portion 342 of the belt 340 to the braking pulley 310. Below the tensioner wheel 320, a slip post 330 guides a lower portion 344 of the belt 340. The wheel 320 guides the lower toothed side of the upper portion of the belt, the slip post 330 guides the lower smooth side of the lower portion of the belt, and the wheel 320 and post 330 support and maintain the two belt portions as parallel as the belt moves. Due to the belt passing around a fixed forward turn point, making there a one-hundred and eighty degree turn, the top portion 342 of the belt 344 moves linearly and oppositely directed relative to the movement of the structure 52. The lower portion 344 of the belt moves linearly and in the same direction as the structure 52. Motion of the belt rotates the hub 312 and the pulley flanges 314 therewith, with tangential speed amplification along the flanges 314 increasing outward from the center of rotation.

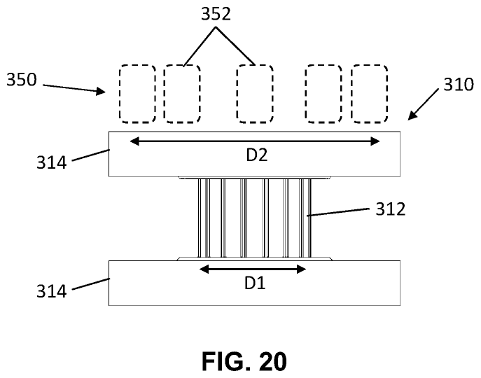

A respective ring array 350 of stationary non-rotating magnets 352 is mounted within the housing 302 proximal and adjacent each lateral side of the braking pulley 310. Each ring array 350 causes eddy current braking in a respective pulley flange 314 as the belt moves and rotates the braking pulley. The magnets of the ring arrays are radially spaced further from the axis of rotation of the braking pulley than the belt engaging surface. The belt engagement surface of the hub, having a diameter D1 (FIG. 20), has a tangential speed matching the speed of the moving belt 340. However, each ring array 350 has a greater effective diameter D2, and thus the closest portions of flanges 414 to the magnets 352 have a greater tangential speed than the speed of the moving belt 340, which produces a greater eddy current braking effect.

As with other structures in which eddy current braking is to be generated in these descriptions, the pulley flanges 314, and optionally the hub 312 therewith, can be constructed of aluminum, as a non-limiting example, or other electrically conducting material or metal, facilitating eddy-current interaction and optionally having little or no ferromagnetic property.

In the system installation illustrated in (FIG. 17) of which the movement damping device 300, the belt 340 and two trolleys are each a part, a first end 346 of the belt 340 is connected to the forward end of a forward first trolley 360 mounted on a door or other moving structure 52 for which motion damping is wanted. The second opposing end 348 of the belt is connected to the rearward end of a rearward second trolley 362 mounted on the door. The trolleys 360 and 362 can be as described above with reference to the trolley 130, with or without a braking follower 150, by which the door can be supported via the trolleys in a track, for example the track 180. The trolleys 360 and 362 can as described above with reference to the trolley-form damping device 200. These an other examples of trolleys for support of the door as the trolleys are supported by and roll along a track, rails, or other structure, are all within the scope of these descriptions.

The top portion 342 of belt extends from a fixed turn point 364 forward of the first trolley 360 and back to the movement damping device 300. The turn point 364 can be defined, for example, by a tensioner wheel or other freely rotating element. A second line-coupled damping device 300a having a braking pulley, as already described with reference to the device 300, can be provided as represented in FIG. 17, to be attached to a supporting stationary host structure, such as a forward end or portion of a track, to serve as the turn point and to provide damping against the movement of the structure 52 in cooperation with the device 300.

In any event, FIG. 17 represents that the door or other moving structure 52 reciprocates forward toward the turn point 364 and rearward toward the movement damping device 300, where motion is damped by eddy current braking at least in one movement damping device 300.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A motion damping system for a movable door, the system comprising:
a trolley having rotatable wheels, the trolley configured for mounting a movable door;
a stationary track on which the rotatable wheels are supported, the stationary track comprising an electrically conducting material; and
a braking follower attached to the trolley, the braking follower comprising at least one magnet array in proximity to the electrically conducting material of the stationary track,
wherein upon movement of the trolley relative to the stationary track, the braking follower is moved by the trolley relative to the stationary track such that the at least one magnet array causes eddy currents in the electrically conducting material and thereby resists the movement.

2. The motion damping system of claim 1, wherein the electrically conducting material comprises aluminum.

3. The motion damping system of claim 1, wherein the braking follower has a proximal end attached to the trolley, and a distal end having roller wheels.

4. The motion damping system of claim 3, wherein:
the follower comprises a chassis extending longitudinally from the proximal end to the distal end; and
the at least one magnet array is mounted on a first lateral side of the chassis.

5. The motion damping system of claim 4, further comprising a second magnet array mounted on a second lateral side of the chassis.

6. The motion damping system of claim 5, wherein the stationary track comprises vertical side plates supporting respective horizontal rails on which the rotatable wheels are supported such that movement of the trolley relative to the stationary track causes eddy currents in the vertical side plates.

7. A movement damping device comprising:
at least one frame member;
an axle mounted on the frame member;
at least one roller wheel rotatably mounted on the axle;
a hub rotatably mounted on the axle with the roller wheel, the hub comprising an electrically conductive material; and
at least one magnet section non-rotatably attached to the frame;
wherein upon rotation of the roller wheel, the hub is rotated relative to the at least one magnet section such that eddy currents in the electrically conducting material cause resistance against the rotation.

8. The movement damping device of claim 7, wherein the at least one magnet section comprises a first cylindrical shell section magnet concentrically nested at least partially around the hub.

9. The movement damping device of claim 8, further comprising a second cylindrical shell section magnet non-rotatably attached to the frame and concentrically nested at least partially around the hub.

10. The movement damping device of claim 7, further comprising a base from which the at least one frame member extends, the base configured for mounting the movement damping device to a movable host structure for damping movement thereof.

11. The movement damping system of claim 10, wherein the electrically conducting material comprises aluminum.

12. A motion damping system for coupling to a movable structure to which motion damping is applied by the system, the motion damping system comprising:
a movement damping device comprising:
a frame;
a braking pulley comprising a hub rotatably attached to the frame, and at least a first flange extending radially outward from the hub, the first flange comprising an electrically conducting material; and
at least one magnet non-rotatably attached to the frame adjacent the first flange, and
a flexible line engaging the hub of the braking pulley, the flexible line having at least one end for attachment to a movable structure,
wherein upon linear movement of the flexible line relative to the movement damping device, the flexible line causes rotation of the braking pulley such that eddy currents in the electrically conducting material of the first flange causes resistance against the rotation.

13. The motion damping system of claim 12, the movement damping device comprising at least a first ring array of magnets, including the at least one magnet, non-rotatably attached to the frame adjacent the at least one flange, each of the magnets of the first ring array, upon rotation of the braking pulley, causes eddy currents in the electrically conducting material and resistance against the rotation.

14. The motion damping system of claim 13, wherein:
the braking pulley further comprises a second flange extending radially outward from the hub, the second flange comprising an electrically conducting material;
the movement damping device further comprises a second ring array of magnets non-rotatably attached to the frame adjacent the second flange, wherein each of the magnets of the second ring array, upon rotation of the braking pulley, causes eddy currents in the electrically conducting material of the second flange and resistance against the rotation.

15. The motion damping system of claim 14, wherein:
the flexible line comprises a toothed belt; and
the hub has a toothed engagement surface for positively engaging the toothed belt without slipping.

16. The motion damping system of claim 12, wherein the electrically conducting material comprises aluminum.
